(19) United States
(12) Patent Application Publication
(10) Pub. No.: US 2009/0254455 A1
(43) Pub. Date: Oct. 8, 2009

(54) SYSTEM AND METHOD FOR VIRTUAL CANVAS GENERATION, PRODUCT CATALOG SEARCHING, AND RESULT PRESENTATION

(75) Inventors: James Rothey, Oakton, VA (US); Rob Weagent, Warrenton, VA (US); Hui Li, Herndon, VA (US); Bill Haskitt, Ashburn, VA (US)

Correspondence Address: LAW OFFICE OF DUANE S. KOBAYASHI, P.O. Box 4160, Leesburg, VA, 20177, US

(73) Assignee: Whereoware, Herndon, VA (US)

(21) Appl. No.: 12/371,720

(22) Filed: Feb. 16, 2009

Related U.S. Application Data
(60) Provisional application No. 61/042,461, filed on Apr. 4, 2008.

(51) Int. Cl. G06Q 30/00; G06F 17/30

(52) U.S. Cl. 705/27; 707/5; 707/104.1; 707/E17.108; 707/E17.044

(57) ABSTRACT

A system and method for virtual canvas generation, product catalog searching, and result presentation. A user that searches multiple virtual catalogs can be provided with search results in a highly useful format. The search results can include a ranked list of product catalogs along with a further display of a non-sequential set of catalog page images that include product information. Virtual canvases can also be created that are customized based on various criteria, such as the characteristics of the user device. The virtual canvas can also include supplemental data that is associated with the search result set.

This application claims priority to provisional application No. 61/042,461, filed Apr. 4, 2008, which is incorporated by reference herein, in its entirety, for all purposes.

### TECHNICAL FIELD

The present invention relates generally to product catalogs. More particularly, the present invention relates to a system and method for virtual canvas generation, product catalog searching, and result presentation.

### BACKGROUND

Consumers often employ the Internet to conduct purchases and to research goods and services (herein collectively referred to as “products”). As such retailers and manufacturers are increasingly offering their products via on-line catalogs. One method of doing so is to provide an on-line catalog that is designed to appear and function similarly to a traditional print catalog. Such a “virtual catalog” can employ an interface that enables a user to interact with it as if it were made of paper, such as by using animation to simulate turning pages. A virtual catalog can be generated from data acquired from an existing print catalog or from electronic source data. Virtual catalogs can be searchable and some searching services enable a user to search multiple catalogs at one time. However, apart from ranking search results (i.e., relevant catalogs) in order of text relevancy, such services do not provide search results grouped by product data embedded in the catalog or by data associated with regions of the catalog, and they do not perform relevancy ranking at the product level. What is needed is a system for providing virtual catalog search results at the product level in a more useful manner.

Additionally, due to their design, virtual catalogs are not optimized to be added to the indexes (i.e., to be “crawled”) by public Internet search engines, such as Google. Therefore, what is additionally needed is a system that enables the search engine optimization of virtual catalogs.

Current virtual catalogs are designed to function with static virtual pages and, therefore, virtual catalog services lack the ability to generate a virtual catalog page or entire virtual catalog from product search results. As such, what is needed is a system that enables the dynamic generation of one or more virtual catalog pages based on a given product set (i.e. search result data set).

### SUMMARY

A system and method for virtual canvas generation, product catalog searching, and result presentation, substantially as shown in and/or described in connection with at least one of the figures, as set forth more completely in the claims.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof that are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an example of a general architecture overview of a virtual canvas generation and presentation system.

FIG. 2 illustrates an example of an embodiment of a search result set provided by the system of the present invention in which supplemental data is included for each result.

FIG. 3 illustrates an example of an embodiment of a search result set provided by the system of the present invention in which one or more images of virtual canvases are included in the supplemental data included for each result.

FIG. 4 illustrates a flowchart of a process of creating a virtual canvas.

FIG. 5 illustrates an example of an embodiment of a dynamically generated virtual canvas.

### DETAILED DESCRIPTION

Various embodiments of the invention are discussed in detail below. While specific implementations are discussed, it should be understood that this is done for illustration purposes only. A person with ordinary skill in the relevant art will recognize that other components and configurations can be used without parting from the spirit and scope of the invention.

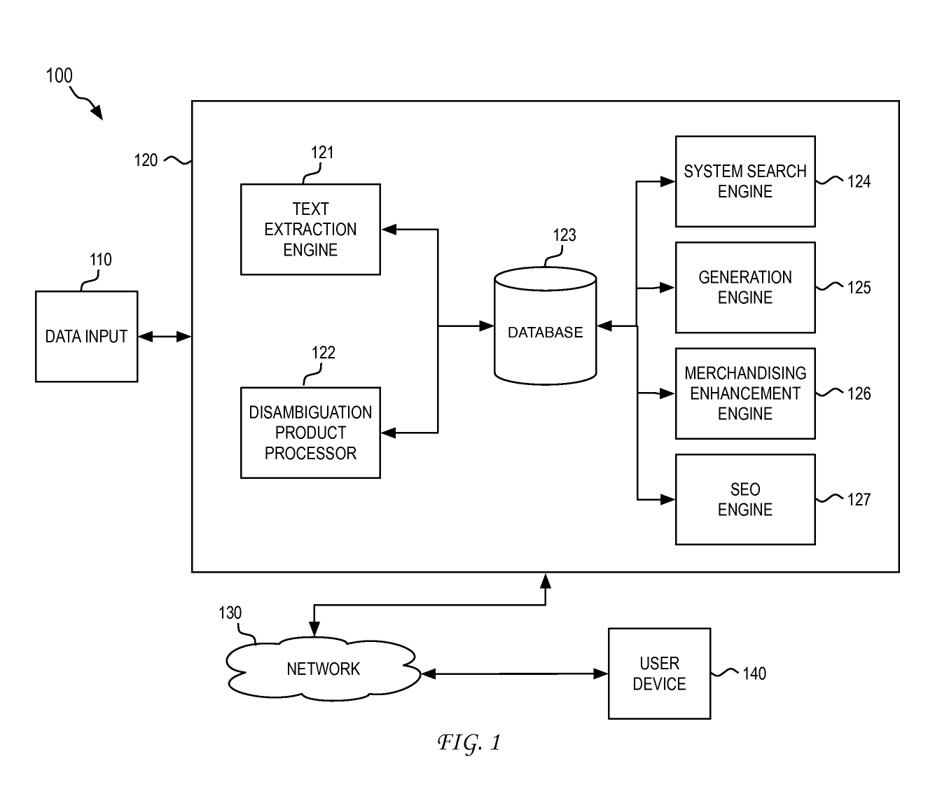

FIG. 1 illustrates an example of general architecture overview of a virtual canvas generation and presentation system 1 00. The system 100 as described herein can enable the generation, storage and display of a “virtual canvas.” A virtual canvas can be a presentation in which one or more objects, such as products, are electronically displayed. The objects can be configured to be displayed to optimize the capabilities of the display device, to optimize the picturesque nature of the composition, to focus the user on particular objects (e.g., the most popular products, the most profitable products, the newest products, etc.) and/or to present an object as part of a collection or as part of a logical group. In one embodiment, a virtual canvas can be generated based on print catalog data or electronic catalog data. Multiple virtual canvases can be associated to compose a virtual catalog. Although a virtual canvas is typically described herein in terms of virtual catalog usage, that is not to be construed as limiting as a virtual canvas generated by the system 100 can be implemented in various manners. For example, a virtual canvas can be employed as a substitute for a thumbnail grid-based on-line product catalog.

One or more types of known data networks, such as a wired and/or wireless network, can connect the components of the system 100. The system 100 can include one or more data input mechanisms 110 that acquire catalog information and product data. In various embodiments, a data input mechanism can enable the capture of product still images, product motion images, product metadata, or a combination thereof. Product metadata can include a product name, a description, a category, a price, a product number, stock-keeping unit (SKU) data, Universal Product Code (UPC) data, other textual data, and the like.

In one example, data input mechanism 110 can be a scanner that can acquire data from printed product images or print catalog pages. The data acquired can include various elements, such as product images, textual data associated with an image (e.g., price, description, product number, etc.), textual data associated with a catalog page (e.g., page number, section number, heading, footer, etc.), and the like. In another example, data input mechanism can be a video camera or motion capture device that can acquire motion data associated with a product. This motion data can include streams of the product in action, or the like, and associated textual data. In yet another example, data input mechanism 110 can be a keyboard, a bar code reader, or the like that can be employed to provide product metadata.

The data acquired from data input mechanism 110 can be relayed to the virtual canvas creator (VCC) 120 for processing. VCC 120 can include various components that employ the received data to generate and store one or more virtual canvases. As with the overall system 100, the components of VCC 120 itself can be connected by one or more types of known data networks, such as a wired and/or wireless network.

In the illustrated embodiment, VCC 120 can include text extraction engine 121 for extracting textual data acquired from still image data and motion data. In one embodiment, textual data can be extracted via optical character recognition (OCR) technology. In addition to extracting textual data from still images, OCR technology can be employed to extract textual data included on a product depicted in motion data, as well as text contained in the motion stream itself, such as closed caption text or speech to text processing. Additionally, verbal information included in the audio of the motion data soundtrack can be extracted as textual data. Extracted textual data can be stored in a product record in database 123, thereby associating the textual data with other product metadata to enable full text searching.

VCC 126 can also include disambiguation product processor 122 that can associate images, such as catalog page images and product images, with related product metadata and actionable user interface events, thereby creating one or more product zones. For example, disambiguation product processor 122 can analyze product images and textual data associated with a catalog page image to identify one or more product zones. In general, a product zone can be a merchandising area of a virtual canvas. Although disambiguation product processor 122 can operate automatically, it can also serve as a manual interface and enable an administrator to assist with the identification of product zones. As mentioned, once a product zone has been identified, disambiguation product processor 122 can then enable it with one or more events actionable per user input (e.g., mouse click, mouse over, etc.). For example, an actionable event can be a mouse click that initiates a display of motion data associated with a product or a display of another page or screen containing additional information or images of the product(s) in the product zone.

Database 123 of VCC 120 can store data received from data input mechanism 110, product metadata obtained by text extraction engine 121, and product zone associations as determined by disambiguation product processor 122. As aforementioned, all information associated with a particular product can be associated in a product record stored in database 123. A product record can contain an indication of the product's source (e.g., which catalog and/or merchant), image data (e.g., still and/or motion), product metadata, the relative location of textual data as it appears in the source material, and the like. Two-dimensional characteristics can be employed for still images, while three-dimensional characteristics can be used for motion data so that a relative time based on the beginning of the media source can be incorporated. Database 123 can also associate product records related to a particular virtual catalog for viewing related virtual canvases (e.g., virtual catalog pages), related products, or relevant portions of a product video or other motion-based stream. When being accessed by system search engine 124 (as described below), database 123 can enable the location of all data associated with a product. For example, if system search engine 124 receives a query for a baseball cap, it can access all relevant information regarding baseball caps. If associated motion data includes information extraneous to the queried product, the product record can indicate where the relevant product information is located in the motion data. For example, if the motion data is a ten-minute video about various baseball products, the product record can indicate that baseball cap information is displayed during time code 5:03 to 5:33. Furthermore, system search engine 124 can provide only the relevant data (e.g., video starting at 5:03 and stopping at 5 :33).

Once the product information has been stored in database 123, generation engine 125 can generate a virtual canvas based on the stored data. Generation engine 125 can generate multiple virtual canvases to create a virtual catalog. Virtual canvases created by generation engine 125 can be integrated with a Web site, such a merchant site or directory site. A virtual canvas can display multiple products in various fashions.

The virtual canvas can be accessed from VCC 120 by a user via user device 140. The characteristics of user device 140 can vary per implementation of the present invention and user device 140 can be exemplified by a personal computer, an electronic kiosk, a mobile device (e.g., a mobile phone, a personal digital assistant, etc.), or the like. VCC 120 and user device 140 can communicate via network 130. Network 130 can be the Internet or another wide-area network (WAN), a local area network (LAN), a mobile network, a telephone network, or the like. Furthermore, network 130 can be a wired and/or wireless network.

A user can employ user device 140 to interact with VCC 120 to view a virtual canvas, one or more sets or subsets of virtual canvases (e.g., virtual catalogs), or to interact with a virtual canvas and the product metadata contained therein. For example, the user can interact with the VCC 120 via a web browser or an email client included with user device 140. The user can input a search query to search canvases from a single virtual catalog or from multiple virtual catalogs. System search engine 118 can receive the query and evaluate it against product metadata associated with the virtual canvases stored in database 123. System search engine 124 can limit its search to the products and/or virtual canvases (e.g., virtual canvases) associated with the Web site that the user is viewing. Once system search engine 124 determines a result set, the result set is relayed to user device 140 and can be displayed in a variety of ways.

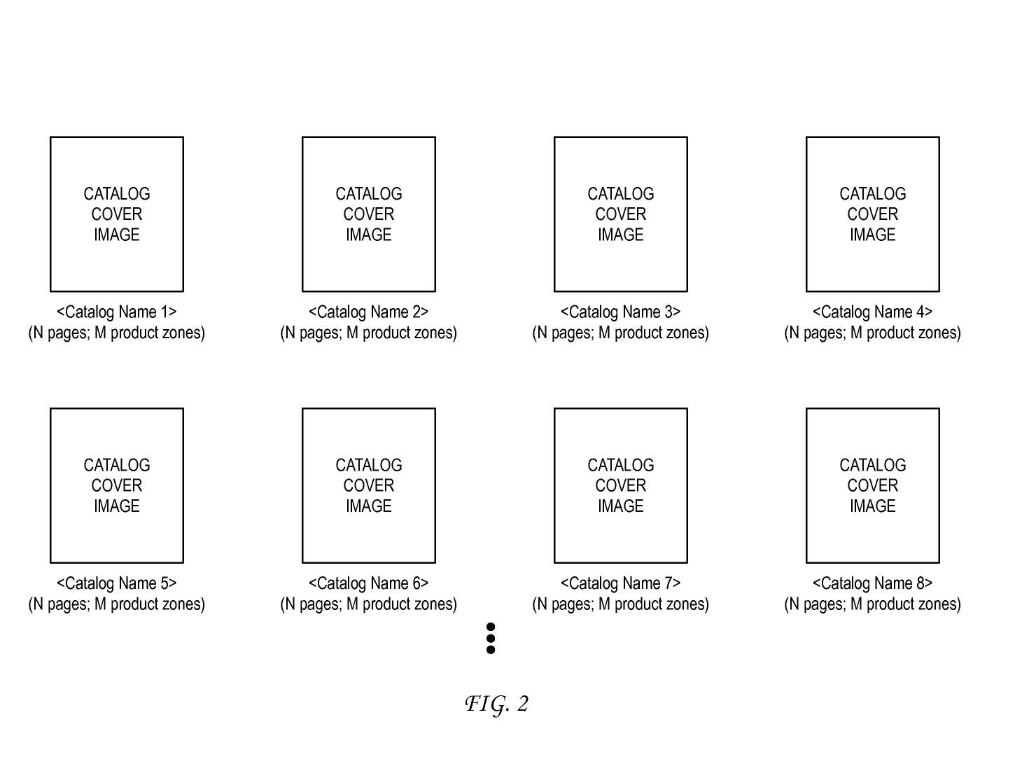

If the user has conducted a search of multiple virtual catalogs, the result set can include a visual relevancy ranking of catalogs based on the number of virtual canvases (e.g., virtual catalog pages) that match the search query. As illustrated in FIG. 2, in one embodiment, a catalog cover image can be presented for each catalog in the result set. These catalog cover images can also be displayed in order of relevancy. Supplemental data that explains a catalog's ranking can be included adjacent to each individual search result (i.e., with each catalog cover image). In one scenario, the supplemental data includes the number of matching catalog pages (“N pages”) and/or the number of matching product zones within those pages (“M product zones”). The greater the number of matching catalog pages and matching product zones, the higher a virtual catalog's ranking.

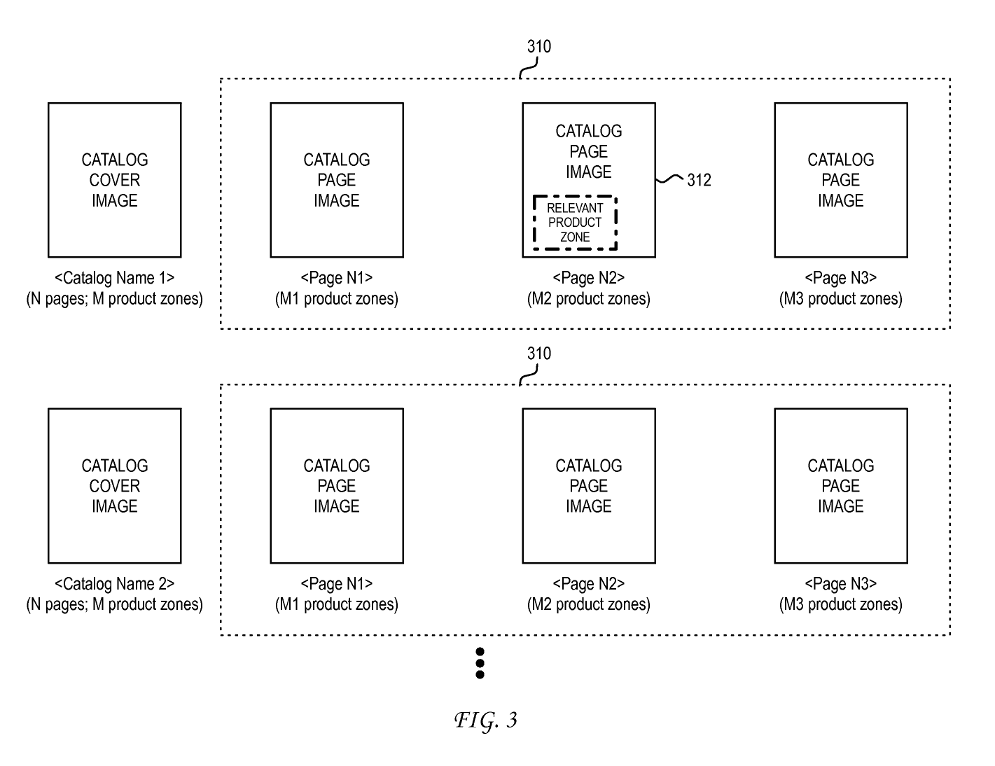

As illustrated in the example of FIG. 3, in addition to the aforementioned supplemental data, images of matching catalog pages can be displayed in proximity to the catalog cover image using matching catalog page areas 3 10. In one embodiment, catalog page areas 310 are displayed in a pop-up window upon mouse click or mouse over of the catalog cover image.

Here, it should be noted that catalog page area 310 can be designed to include only those catalog pages that match the user's search query. This is in contrast to conventional systems that merely reproduce catalog pages sequentially, thereby mirroring the numbered ordering of pages in the original catalog. In accordance with the present invention, the matching catalog pages are displayed non-sequentially as only those pages that match the user's search query are included. This targeted display of catalog pages enables the user to ascertain quickly whether or not any of the matching catalog pages include products for which the user might have an interest.

In one embodiment, supplemental data associated with each of the matching catalog pages can also be included. As illustrated in FIG. 3, the number of product zone matches can also be displayed adjacent to the matching catalog pages. As illustrated by the example of catalog page image 312, the relevant product zones on each of the individual page images can also be highlighted to indicate the location on the catalog page that is the basis for the match. While the specific mechanism used for highlighting a relevant product zone (e.g., outlining, coloring, arrows, etc.) can be implementation dependent, it is recognized that the visual cue along with the display of matching catalog pages will provide the user with an easy tool to scan the results of the search query.

In a further embodiment, the system administrator and/or user can further specify certain thresholds that can be used to limit or otherwise produce the best displayed results. For example, a threshold can be established such that only those pages that exceed the established threshold would be displayed. This mechanism ensures that a large result set can be pared down to a manageable number for viewing analysis.

In the user interface such as that exemplified in FIG. 3, a user can select (e.g., click) a catalog cover image or a catalog page image in order to view the data it contains. The user can then select a product zone to view more information about a product and/or to associate the product with a pending transaction record, such as a virtual shopping cart or virtual shopping basket. The user can then access the pending transaction record to interact with those products, such as to view product information, remove the product, modify a quantity, or the like. A user can also initiate a purchase transaction from the pending transaction record.

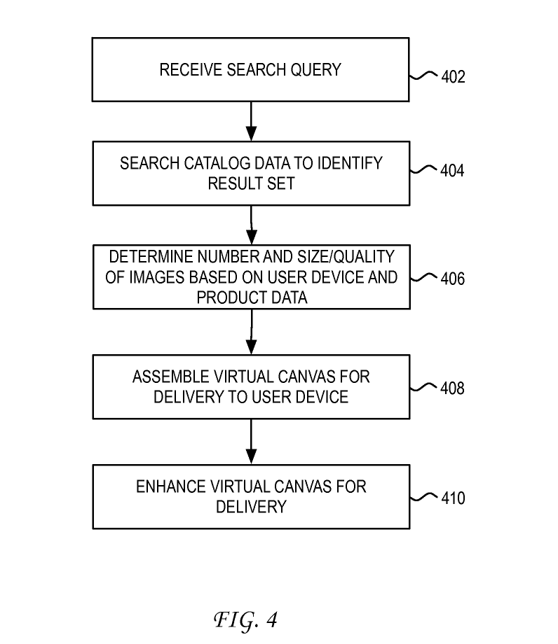

In addition to the aforementioned methods of displaying a multiple virtual catalog search result set, the system 100 can also enable the dynamic generation of a virtual canvas. To illustrate this feature of the present invention, reference is now made to the flowchart of FIG. 4. As illustrated the process of FIG. 4 begins at step 402 where a search query is received from a user device. At step 404, the catalog data is then searched using the search query to identify a result set. In a conventional system, this result set can be displayed in a simple uniform listing that is arranged vertically and/or horizontally on a page. This listing is statically generated based on simple database lookups of product images and metadata.

In accordance with the present invention, a virtual canvas is created dynamically. After the identification of a result set, generation engine 125 can determine, at step 406, the number and size/quality of product images that should be included in a virtual canvas. As such, the number and size/quality of product images included within a displayed virtual canvas can be dynamically configured in response to the particulars of a result set and/or the particulars of the user device employed.

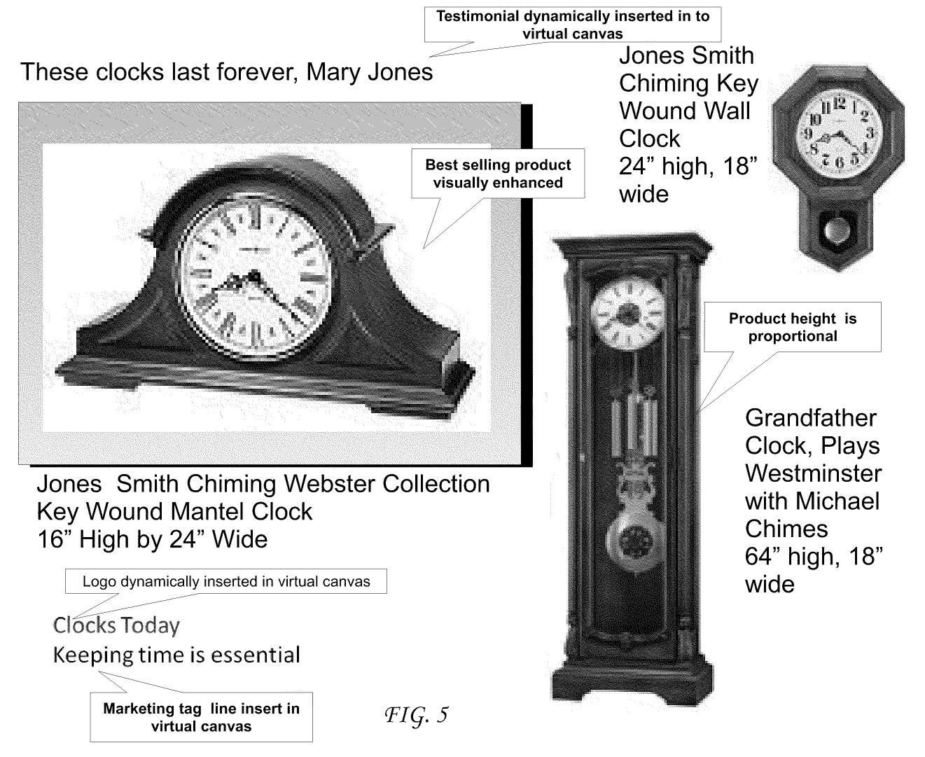

In one embodiment, the size and/or quality of product images presented can vary based on relevancy (e.g., the best match), popularity (e.g., the most sold), relative product sizes, or a combination thereof. System search engine 124 can generate a relevancy or popularity score based on a search query and relay this information to generation engine 125. Here, a high score increases the size and/or quality of a product image compared to a product with a low score. In another embodiment, the size and/or quality of product images presented can vary per the relative size of products depicted. For example, the largest product presented on a virtual canvas can be displayed with the largest and/or highest quality product image. As image size can be based on the relative size of all products on the same virtual canvas, the size of a product can vary based on the particulars of the result set and, in turn, the products to be displayed. As illustrated in FIG. 5, generation engine 125 can generate a larger image for a product with large dimensions, such as a grandfather clock, than a product with small dimensions, such as an alarm clock. For the same alarm clock, however, generation engine 125 can generate a larger image if the rest of the virtual canvas is to be populated with smaller products, such as watches.

In one embodiment, the configuration of the virtual canvas can also vary per the characteristics of the user device on which the virtual canvas is to be displayed. When communication is established between VCC 120 and user device 140, VCC 120 can receive an indication of the characteristics of user device 140. Generation engine 125 can then employ this user device characteristic information in tailoring the virtual canvas to the user device. A virtual canvas can therefore be configured for any size display device or output mechanism, such as small phone screens, extremely large wall-sized high definition displays, A4 paper size, or the like. For example, if the user device is a small device, such as a mobile phone, then the virtual canvas can include only a few product images rather than multiple small images that might be hard for the user to discern. Conversely, if the user device includes a large display screen, the virtual canvas can include many product images and/or include larger product images to utilize the capabilities of the display. In general, the number and size/quality of the images can be tailored for the particular user device on which the virtual canvas is to be displayed.

After the appropriate number and size/quality of the relevant product images have been determined, generation engine 125 can then assemble the virtual canvas at step 408 using the dynamically-configured product images. In this assembly, the location of each product image on the virtual canvas can also be based on factors such as relevance, popularity, and/or size.

In one embodiment, VCC 120 can also dynamically enhance the virtual canvas at step 410 using merchandising enhancement engine 126. Once generation engine 125 has generated a virtual canvas, it can relay the results to merchandising enhancement engine 126, determines whether any enhancements should be added. In this enhancement process, the virtual canvas can be configured to include optimized product descriptions matching the search query. For example, a search query including the text “go green” can result in a virtual canvas that includes products based on the metadata “recycled.” Rather than using the “recycled” metadata terminology, however, merchandising enhancement engine 126 can optimize the virtual canvas to include the user's own vernacular (i.e., “go green”) used in the search request. The resulting virtual canvas will therefore be perceived as presenting results that are seemingly more on target with the user's search. In one embodiment, merchandising enhancement engine 126 can employ natural language processing to determine matches between the search queries and product metadata associated with the product zones of a virtual canvas.

In another example, merchandising enhancement engine 126 can add enhancement materials to the virtual canvas. For example, merchandising enhancement engine 126 can add logos, testimonials, marketing tag lines, or the like to the virtual canvas. The illustration of FIG. 5 provides such an example where merchandising enhancement engine adds the logo “Clocks Today,” a testimonial by Mary Jones, and a tag line “Keeping time is essential” to the virtual canvas. As would be appreciated, merchandising enhancement engine 126 can use the product metadata associated with products identified in the result set to determine what, if any, enhancement material is appropriate.

In addition to the aforementioned features, system 100 can also make a virtual canvas usable (i.e., “crawlable”) by text-based public search engines, such as Google, Yahoo, and the like. Product metadata, such as extracted textual data from still and motion images, can be added to a hypertext markup language (HTML) page to make the virtual canvas (e.g., virtual catalog page) suitable for crawling. By doing so, product metadata can be accessible to a public search engine thereby enabling it to include products within a virtual canvas in its search result sets. The HTML can be constructed to show a virtual catalog spread, such as by presenting two virtual catalog pages like an open print catalog. Search engine optimization (SEO) engine 127 of VCC 120 can create metadata for the HTML page by extracting information associated with the virtual canvases of a catalog and the products on the virtual catalog spread. Although SEO engine 127 can do so automatically, it can also enable an administrator to assist. SEO engine 127 can generate a unique keyword description based on textual data included in the product metadata associated within the virtual catalog pages. SEO engine 127 can select the most descriptive keywords, the most unique keywords, or a combination thereof in order to boost rankings for a given search term. By analyzing search engine performance, search engine keyword data sources, frequency of keyword usage, relative value of current keyword ad cost, and the like, SEO engine 127 can select keywords to provide the best overall ranking value. The ranking results can further be enhanced by selecting more unique or new keywords via a thesaurus application. A semantic word network can be used to associate concepts with existing product metadata. For example, if product metadata describes the product as “recycled,” but the ranking score of “recycled” is relatively low, SEO engine 127 can replace “recycled” with an associated phrase that is newer and/or more popular, such as “go green.” In the body of the HTML, the product zones and product metadata can be included in the layout per the coordinates of the textual data or the location of a product zone. SEO engine 127 can employ refresh rates so the HTML page can be modified when a virtual canvas changes, when a product associated with a virtual canvas changes, or in an automated refresh mode. In an automated refresh mode, SEO engine 127 generates the HTML page with new or refresh content by selecting different weighting values to create a unique HTML page on a periodic basis. This allows public search engines to treat the Web page as if it was a news service page (e.g., CNN.com) in which there are new news articles to index periodically.

Although the invention has been described mainly in terms of a virtual catalog, this is not to be construed as limiting, as the processes described can be employed for any type of presentation medium. For example, the dynamic catalog page generation processes can be employed to generate a presentation for any type of electronic catalog or to generate a printed catalog page. It should also be noted that a virtual canvas does not need to be persistent or previously existing. A virtual canvas can be used to show any type of search results dynamically. For example, instead of showing a grid of thumbnails for a “wooden clock” search query, the system 100 can generate a dynamic result set including one or more virtual canvases to display wooden clocks incorporating all merchandising techniques described above.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention. Therefore, the description should not be considered to be exclusive of these other embodiments. Also, it is to be understood that the phraseology and terminology employed herein are for the purposes of description and should not be regarded as limiting.

The invention claimed is:

1. A catalog searching method, comprising:
a. receiving product catalog search criteria;
b. searching catalog data of one or more product catalogs to produce search results; and
c. transmitting search result information to a user device, said transmitted search result information enabling said user device to display a ranked list of product catalogs, wherein said display of said ranked list of product catalogs enable a further display for one of said product catalogs of a non-sequential set of catalog page images that include product information that matches said product catalog search criteria.

2. The method of claim 1, wherein said searching comprises searching a single product catalog.

3. The method of claim 1, wherein said searching comprises searching a plurality of product catalogs.

4. The method of claim 1, wherein said transmitting comprises transmitting relevancy data that identifies a relevancy for each product catalog in said ranked list.

5. The method of claim 4, wherein said transmitting comprises transmitting information identifying a number of matching catalog pages and/or product zones.

6. The method of claim 1, wherein said display of said non-sequential set of catalog page images highlights relevant product zones on said non-sequential set of catalog page images.

7. A catalog searching method, comprising:
a. transmitting a product catalog search request based on product catalog search criteria received from a user;
b. receiving product catalog search result information that is generated in response to said transmitted product catalog search request;
c. displaying a non-sequential set of catalog page images that include product information that matches said product catalog search criteria proximate to a product catalog image in a ranked list of product catalog images.

8. The method of claim 7, wherein said ranked list of product catalog images includes information that identifies a number of matching catalog pages and/or product zones.

9. The method of claim 7, wherein said displaying comprises displaying a non-sequential set of catalog page images that have highlighted product zones.

10. A virtual canvas creation method, comprising:
a. receiving product catalog search criteria;
b. identifying a set of products based on said received product catalog search criteria; and
c. transmitting images of said identified set of products to a user device for a concurrent display of said transmitted images on a virtual canvas on said user device, wherein a size or quality of an image of at least one of said transmitted images is selected after receipt of said product catalog search criteria.

11. The method of claim 10, further comprising selecting a size or quality of an image based on a relevancy to said received product catalog search criteria.

12. The method of claim 10, further comprising selecting a size or quality of an image based on a popularity of a product associated with said image.

13. The method of claim 10, further comprising selecting a size or quality of an image based on a relative size of said identified set of products.

14. The method of claim 10, further comprising transmitting relative location information for said images on said virtual canvas.

15. The method of claim 14, wherein said transmitting relative location information comprises transmitting relative location information that is based on a relevancy to said received product catalog search criteria.

16. The method of claim 14, wherein said transmitting relative location information comprises transmitting relative location information that is based on a popularity of a product associated with said image.

17. The method of claim 14, wherein said transmitting relative location information comprises transmitting relative location information that is based on sizes of said identified set of products.

18. A virtual canvas creation method, comprising:
a. receiving, from a user device, product catalog search criteria;
b. identifying a set of products based on said received product catalog search criteria; and
c. receiving, from said user device, an indication of a display characteristic of said user device;
d. identifying a configuration of a virtual canvas based on said received indication of said display characteristic, said virtual canvas including a plurality of images representative of at least some of said identified set of products; and
e. transmitting information for said identified configuration to said user device for display of said virtual canvas on said user device.

19. The method of claim 18, wherein said display characteristic identifies said user device as a mobile device.

20. The method of claim 18, wherein said display characteristic identifies a size of a display of said user device.

21. The method of claim 18, wherein said identifying a configuration comprises identifying a number of images to be displayed in said virtual canvas.

22. The method of claim 18, wherein said identifying a configuration comprises identifying a size of one or more images to be displayed in said virtual canvas.

23. A virtual canvas generation system, the system comprising:
a. a text extraction engine that extracts textual data from image data;
b. a disambiguation product processor that generates a product zone by associating image data with an element of related product metadata and an actionable user interface event;
c. a database that stores image data, product metadata, and product zones; and
d. a generation engine that generates a virtual canvas based on data stored in the database.

24. The system of claim 23, wherein said generation engine generates said virtual canvas based on characteristics of a user device.

25. The system of claim 23, wherein said image data is acquired from one or more of print catalog data and electronic catalog data.

26. The system of claim 23, wherein said image data includes one or more of still image data and motion image data.

27. The system of claim 23, wherein said product metadata includes one or more of a product name, a description, a category, a price, a product number, stock-keeping unit (SKU) data, and Universal Product Code (UPC) data.

28. The system of claim 23, further comprising a system search engine, wherein the system search engine queries the database for data per a search query received from a user device and generates a result set including one or more search results.

29. The system of claim 28, wherein said result set is presented with supplemental data as determined by said system search engine.

30. The system of claim 29, wherein said supplemental data includes a number of matching virtual canvases.

31. The system of claim 29, wherein said supplemental data includes a number of matching product zones.

32. The system of claim 29, wherein said supplemental data includes images of one or more matching virtual canvases.

33. The system of claim 28, wherein said generation engine further generates a virtual canvas based on the contents of the result set.

34. The system of claim 33, wherein said generation engine configures the quality or size of an element of image data included on the virtual canvas based on one or more of the popularity of an associated search result and the relevancy of an associated search result.

35. The system of claim 33, further comprising a merchandising enhancement engine, wherein said merchandising enhancement engine adds enhancement materials to the virtual canvas per the result set.

36. The system of claim 33, wherein said enhancement materials is one of a logo, testimonial, and a marketing tag line.

37. The system of claim 23, further comprising a search engine optimization engine, wherein said search engine optimization engine creates metadata for a hypertext markup language page associated with a virtual canvas.

38. The system of claim 37, wherein the hypertext markup language page created by the search engine optimization is searchable by a public search engine.
